(19) United States
(12) Patent Application Publication
(10) Pub. No.: US 2008/0126527 A1
(43) Pub. Date: May 29, 2008

(54) METHOD AND APPARATUS FOR MANAGING INFORMATION FOR MOBILE NETWORK SERVICE

(75) Inventors: Soo-hong PARK, Gwanglu-si (KR); Han-sung Kim, Seongnam-si (KR); Cheol-ju Hwang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/773,060

(22) Filed: Jul. 3, 2007

Related U.S. Application Data
(60) Provisional application No. 60/818,976, filed on Jul. 7, 2006.

(30) Foreign Application Priority Data
Aug. 21, 2006 (KR) 2006-78982

(51) Int. Cl. G06F 15/16

(52) U.S. Cl. 709/223

(57) ABSTRACT

An apparatus for managing information about a mobile network service in a server that manages a network providing the mobile network service, including an information change identification unit which identifies a change in the information about the mobile network service, an information transmission unit that transmits a message including the changed information to an information server, and a positive acknowledgement message receiving unit that receives from the information server a positive acknowledgement message that represents acceptance of the changed information. When information about the network service is changed, a message including the changed information is transmitted to the information server, and the message is re-transmitted to the information server a predetermined number of times until the information server transmits an ACK response that indicates acceptance of the changed information.

### CROSS-REFERENCE TO RELATED APPLICATIONS

This application claims the benefit of U.S. Provisional Patent Application No. 60/818,976, filed Jul. 7, 2006 in the U.S. Patent and Trademark Office, and Korean Application No. 2006-78982 filed Aug. 21, 2006, in the Korean Intellectual Property Office, the disclosures of which are incorporated herein by reference.

### BACKGROUND OF THE INVENTION

1. Field of the Invention

Aspects of the present invention relate to a handover in a mobile network, and more particularly, to a method and apparatus to manage information about a mobile network service in a server that manages a network via which the mobile network service is provided.

2. Description of the Related Art

A handover in a mobile network is a technique enabling a mobile node to continuously receive service even while moving from network to network or from place to place. To perform a handover, the mobile node needs information concerning the new network to which the mobile node is moving. This information is referred to as handover information. The mobile node receives handover information about the network to which the mobile node wants to move from an information server.

Every network providing a mobile network service has a management server to manage the network. The management server stores information about the networks it manages. If any of the information changes, the management server needs to verify and update the changed information.

To give accurate information about the network to the mobile node, the information server should have up-to-date information from the management server. Accordingly, in order to update and manage the information server, the management server of the network needs to periodically transmit changed information to the information server. However, at present, service providers (SPs) directly manage information about corresponding networks. Moreover, no methods to dynamically manage information about a variety of networks exist.

### SUMMARY OF THE INVENTION

Aspects of the present invention provide a method and apparatus in which a management server dynamically transmits a change in information about a network service to an information server and manages the information.

Aspects of the present invention also provide a computer-readable recording medium that records a program to execute the method of managing the information about the network service.

Additional aspects and/or advantages of the invention will be set forth in part in the description which follows and, in part, will be obvious from the description, or may be learned by practice of the invention.

According to an aspect of the present invention, there is provided a method of managing information about a mobile network service in a server that manages a network providing the mobile network service, the method comprising: identifying a change in the information about the mobile network service; transmitting a message including the changed information to an information server; and receiving from the information server a positive acknowledgement message indicating acceptance of the changed information.

According to another aspect of the present invention, the message including the changed information may include a field describing the type of the message, a field describing the length of the message, and a field describing the changed information.

According to another aspect of the present invention, the transmitting of the message including the changed information to the information server may include formatting the changed information in a Markup language and transmitting the message to the information server.

According to another aspect of the present invention, the receiving of the positive acknowledgement message from the information server may include receiving from the information server a negative acknowledgement message representing rejection of the changed information; and re-transmitting the message including corrected information to the information server.

According to another aspect of the present invention, the receiving of the negative acknowledgement message and the re-transmitting of the message including the corrected information may be repeated a predetermined number of times.

According to another aspect of the present invention, the receiving of the positive acknowledgement message from the information server may include waiting for the positive acknowledgement message to be transmitted from the information server within a predetermined period of time; and re-transmitting the message including the changed information to the information server the predetermined period of time has elapsed.

According to another aspect of the present invention, the receiving of the positive acknowledgement message from the information server may include receiving from the information server a negative acknowledgement message representing rejection of some of the changed information; and re-transmitting the message including the corrected information to the information server.

According to another aspect of the present invention, the negative acknowledgement message representing rejection of some of the changed information may include a list of the rejected information.

According to another aspect of the present invention, there is provided an apparatus to manage information about a mobile network service and to manage a network providing the mobile network service, the apparatus including: an information change identification unit to identify a change in the information about the mobile network service; an information transmission unit to transmit a message including the changed information to an information server; and a positive acknowledgement message receiving unit to receive from the information server a positive acknowledgement message representing acceptance of the changed information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a network service information managing apparatus according to an embodiment of the present invention;

FIG. 2 illustrates a mobile communications environment to which network service information management according to an embodiment of the present invention is applied;

FIG. 3 is a block diagram illustrating a network layer of a mobile node included in the mobile communications environment shown in FIG. 2;

FIG. 4 is a flowchart illustrating a network service information managing method according to an embodiment of the present invention;

FIG. 5 illustrates a TLV message format according to an embodiment of the present invention;

FIGS. 6A through 6C illustrate an embodiment of TLV messages for use in each operation of the network service information managing method of FIG. 4;

FIG. 7 is a flowchart illustrating an embodiment of a method for a management server to receive a positive acknowledgement (ACK) message when an information server informs the management server that the information server cannot accept some or all of information pieces;

FIG. 8 is a flowchart illustrating a method of preventing an unlimited repetition of operations shown in FIG. 7, according to an embodiment of the present invention; and

FIG. 9 is a flowchart illustrating an embodiment of a method for the management server to receive an ACK message when the information server informs the management server of non-acceptance of some of the information pieces.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

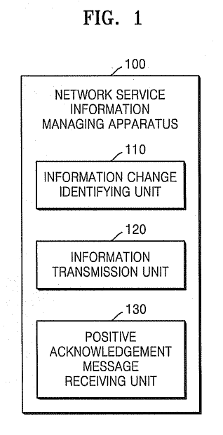

FIG. 1 is a block diagram of a network service information managing apparatus 100 according to an embodiment of the present invention. The network service information managing apparatus 100 includes an information change identifying unit 110, an information transmission unit 120, and a positive acknowledgement (ACK) message receiving unit 130. Other aspects of the present invention may include other components. Similarly, other aspects of the present invention may combine the functionality of two or more of these units into one unit.

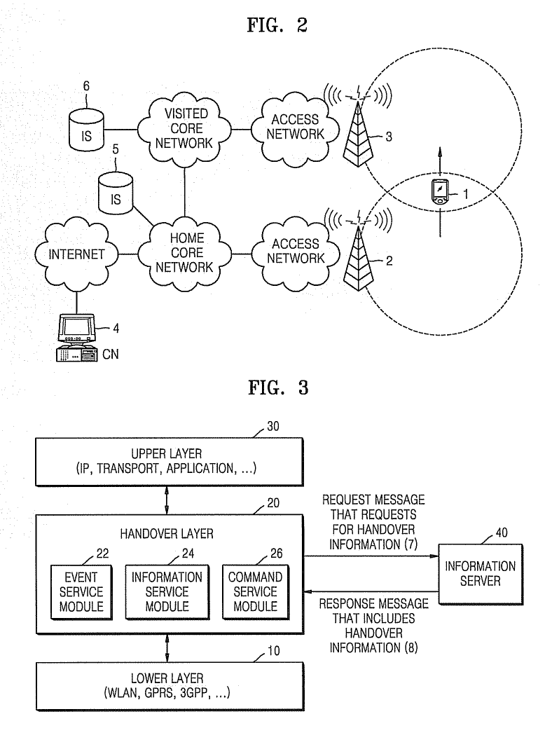

The information change identifying unit 110 identifies changes to information about a network service. The information transmission unit 120 transmits a message including the changed information to an information server, such as information servers 5 and 6 shown in FIG. 2. The positive ACK message receiving unit 130 receives a positive ACK message from the information server indicating acceptance of the changed information by the information server.

FIG. 2 illustrates a mobile communications environment employing network service information management according to aspects of the present invention. The mobile communications environment includes a mobile node 1, network management servers 2 and 3, a correspondent node (CN) 4, information servers (ISs) 5 and 6, and a plurality of networks. The network topology of the mobile communications environment is only an example. According to other aspects of the present invention, the mobile communications environment may have other topologies. While not required in all aspects, the network service managing apparatus is included in one or both of the information servers 5 and 6.

The mobile node 1 is a mobile terminal using the mobile communications environment. When the mobile node starts up, the mobile node 1 registers a home address (HOA) in a home agent (HA) on a home network. When moving to another network area, the mobile node 1 obtains a new address from the new network area. This new address is referred to as a care of address (COA). The mobile node 1 sends the COA to the HA and registers the COA in the HA. The HA matches the COA with the HOA. This matching is referred to as binding update (BU).

The correspondent node (CN) is aware of the HOA of the mobile node 1 and thus transmits data to the HOA of the mobile node 1. The transmitted data is transmitted to the HA. When the HA receives data from the CN, the HA transmits data to the COA corresponding to the HOA.

In a particular network area, Points of Attachment (POAs) connect the mobile node 1 with a network. When the mobile node 1 moves between the POAs, the mobile node executes a layer 2 (L2) handover. In addition, when the mobile node 1 moves between different network areas, the mobile node 1 executes a layer 3 (L3) handover.

FIG. 3 is a block diagram illustrating a network layer of the mobile node 1. The network layer of the mobile node 1 includes a lower layer 10, a handover layer 20, and an upper layer 30. For convenience of explanation, an information server 40 is also shown in FIG. 3.

The lower layer 10 denotes a second layer, or layers lower than the second layer, of the 7 layers defined by the OSI (Open Systems Interconnection) reference model, namely, a link layer, a physical (PHY) layer, etc. The upper layer 30 denotes a third layer, or layers higher than the third layer, of the 7 layers defined by the OSI reference model, namely, an Internet Protocol (IP) layer, a mobile IP layer, a transport layer, an application layer, etc.

The handover layer 20 corresponds to a 2.5-th layer in between the lower layer 10 and the upper layer 30 and supports handover in the lower layer 10 and handover in the upper layer 30. The lower layer 10 executes L2 handover and the upper layer 30 executes L3 handover. The handover layer 20 shown includes an event service module 22, an information service module 24, and a command service module 26. However, the handover layer 20 can be otherwise constructed.

The event service module 22 detects an event generated in the mobile node 1 associated with handover between various links, and informs the upper layer 30 of the event. During execution of handover in the mobile node 1, when the upper layer 30 needs a handover, the event service module 22 transmits a message to the upper layer 30 telling the upper layer 30 to execute an L3 handover.

The information service module 24 acquires handover information from the information server 40. To provide the handover information to the mobile node 1, the information server 40 should maintain up-to-date information about a mobile network service. When the information service module 24 transmits a message 7 requesting handover information from the information server 40, the information server 40 transmits a response message 8 with the handover information to the information service module 24.

The command service module 26 receives a user's command from the upper layer 30 and controls handovers executed in the lower layer 10. During the execution of handover in the mobile node 1, when it is determined that the lower layer 10 needs a handover, the command service module 26 transmits a message to the lower layer 10 telling the lower layer 10 to execute an L2 handover.

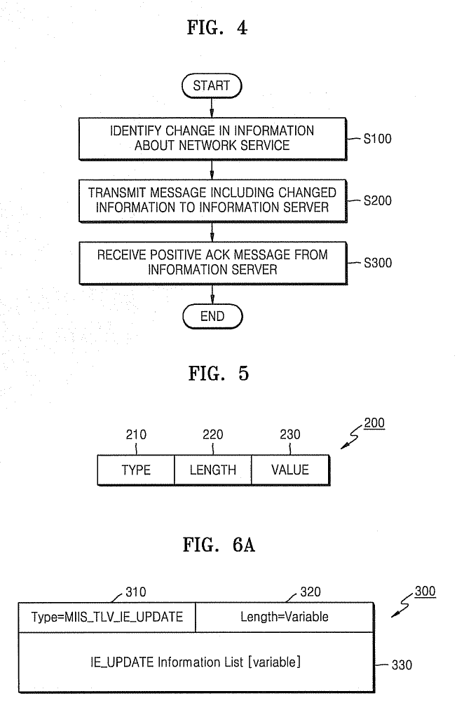

FIG. 4 is a flowchart illustrating a network service information managing technique according to an embodiment of the present invention. The information change identifying unit 110 identifies a change in information about a network service, in operation S100.

When the information is changed, the information transmission unit 120 transmits a message with the changed information to the information server 40 in operation S200. In response to the changed information, the information server 40 sends a positive ACK message. The positive ACK message receiving unit 130 receives the positive ACK message from the information server 40, in operation S300. To send the changed information to the information server 40, aspects of the present invention use a TLV (type-length-value) message having a TLV format. However, the message can use other formats instead of or in addition to the TLV format.

FIG. 5 illustrates a TLV message 200 according to an aspect of the invention. The format of the TLV message 200 includes a field 210 representing the type of the message, a field 220 representing the length of the message, and a field 230 representing the value of the message. A message with changed information, according to aspects of the present invention, is based on the TLV type and includes the changed information in the field 230 representing the value of the message. The message including changed information according to aspects of the present invention may be formatted using a Markup language, such as HTML or XML.

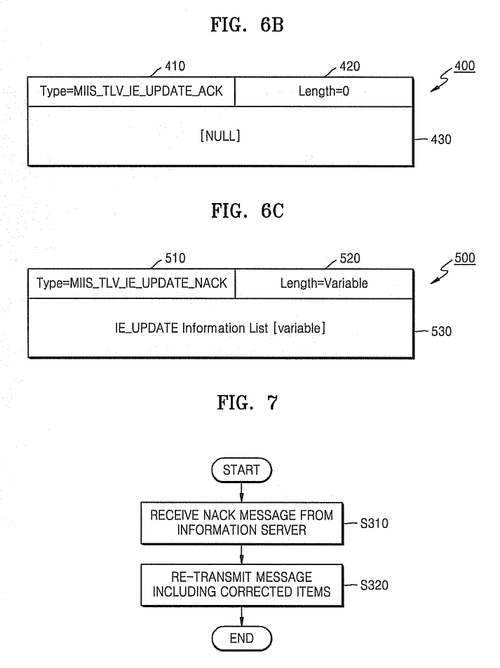

FIGS. 6A through 6C illustrate an embodiment of TLV messages that are used in each operation of the network service information managing method of FIG. 4. FIG. 6A illustrates a message 300 to transmit changed information from a management server (e.g., a server utilizing the management apparatus 100) to an information server, such as the information servers 5 and 6 shown in FIG. 2 or the information server 40 shown in FIG. 3. A message type 310 of the message 300 is “MIIS_TLV_IE_UPDATE”, a message length 320 thereof is variable according to the length of information to be transmitted, and a message value 330 is a list identifying the changed information pieces being transmitted.

FIG. 6B illustrates a positive ACK message 400 that the information server 40 transmits to the management server 100 when the information server 40 can accept the changed information received from the management server 100. The positive ACK message 400 has a message type 410 of “MIIS_TLV_IE_UPDATE_ACK”. Since no other information is necessary to convey acknowledgement, the message 400 has no information as a message value 430, that is, the message value 430 is NULL. Hence, a message length 420 is 0.

FIG. 6C illustrates a negative ACK (NACK) message 500 that the information server 40 transmits to the management server 100 when the information server 40 rejects some or all of the changed information received from the management server 100. Referring to FIG. 6C, the NACK message 500 includes a message type 510 of “MIIS_TLV_IE_UPDATE_NACK”. If all the information was rejected, no other information needs to be included in the message. Thus, the message 500 has no information in a message value 530, and has 0 as a message length 520.

When the information server 40 rejects some of the changed information, the message value 530 of the message 500 is a list in the format in which the changed information is transmitted, and a message length 520 thereof is variable according to the length of the rejected information. Accordingly, a field of the message value 530 includes as an option a list of the rejected information.

FIG. 7 is a flowchart illustrating a technique in which the management server 100 receives a NACK message when the information server 40 rejects some or all of information pieces.

The information server 40 sends a NACK message rejecting the changed information. The management server 100 receives the NACK message transmitted by the information server 40 in operation S310 and recognizes that there is a problem in the message transmitted by the information server 40. These problems may include, for example, transmission of information not needed by the information server 40 or transmission of invalid information (or information having an incorrect value or an unexpected value.) The message may also have been damaged while in transit.

In operation S320, the management server 100 corrects the problem and re-transmits a message with corrected items to the information server 40. This process may be performed not only when the management server 100 receives an NACK message from the information server 40 but also when the management server 100 has not received any message within a predetermined period of time.

When the information server 100 accepts the information included in the re-transmitted message, it sends a positive ACK message to the management server 100. Upon receiving the positive ACK message, the management server 100 recognizes that the changed information has been updated in the information server 40.

However, even if the management server 100 re-transmits a corrected message, the information server 40 may still be unable to accept the corrected message. In this case, the information server 40 responds with another NACK message and the operations S310 and S320 shown in FIG. 7 are repeated. However, an unlimited repetition of this process is not desirable.

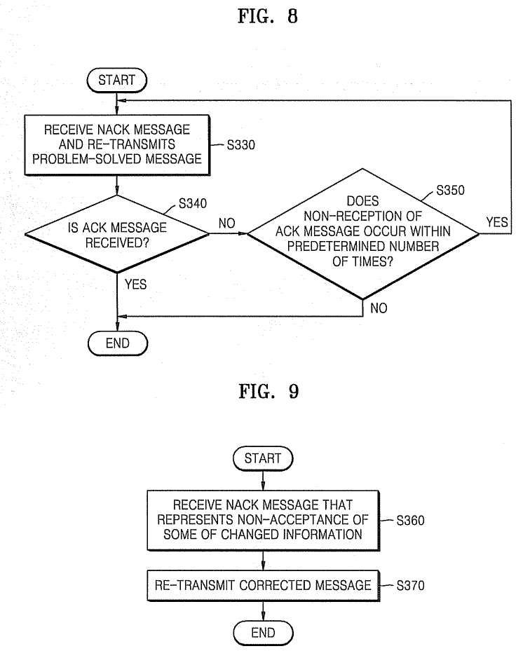

FIG. 8 is a flowchart illustrating a method of preventing the unlimited repetition of the operations of FIG. 7, according to an embodiment of the present invention. First, in operation S330 the management server 100 receives a NACK message and re-transmits a corrected message. Then, the management server 100 waits for an ACK message from the information server 40. If the ACK message is received in operation S340, the operations terminate because the information server 40 has been updated.

However, if no ACK messages are received (that is, if a NACK message is received or no messages are received within a predetermined period of time,) the number of repeated transmissions is determined in operation S350. If the message has not been transmitted the predetermined number of times, the message is re-transmitted. If the message has been re-transmitted the predetermined number of times, the operations terminate.

The same process as that illustrated in FIGS. 7 and 8 may be performed not only when the management server 100 receives a NACK message from the information server 40, but also when an ACK message is not received within a predetermined period of time.

FIG. 9 is a flowchart illustrating an embodiment of a technique for the management server 100 to receive a NACK message when the information server 40 rejects some of the information pieces.

The information server 40 transmits a NACK message 500 illustrated in FIG. 6C. The management server 100 receives the NACK message in operation S360 and checks an information list included in the message value field 530 of the NACK message 500. The information in the NACK message includes the rejected information.

The management server 100 corrects the incorrect information included in the NACK message. When information that the information server 40 does not deal with is included in the NACK message, the information is deleted from the list. The corrected message is re-transmitted to the information server 40, in operation S370. Thereafter, the operations illustrated FIG. 8 may be performed.

In a network service information managing method and apparatus according to aspects of the present invention, when information about a network service is changed, a message including the changed information is transmitted to an information server, and re-transmitted to the information server a predetermined number of times until the information server transmits an ACK response indicating acceptance of the changed information. Thus, information about various networks can be dynamically updated to the information server and managed, and accordingly, latest network information about a mobile node can be provided as handover information.

Aspects of the invention can also be embodied as computer (including any device having an information processing function) readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of managing information about a mobile network service in a server that manages a network providing the mobile network service, the method comprising:
identifying a change in the information about the mobile network service;
transmitting a message including the changed information to an information server; and
receiving from the information server a positive acknowledgement message indicating acceptance of the changed information.

2. The method according to claim 1, wherein the message including the changed information comprises:
a field describing the type of the message;
a field describing the length of the message; and
a field describing the changed information.

3. The method according to claim 1, wherein the transmitting of the message including the changed information to the information server comprises formatting the changed information in a Markup language message and transmitting the message to the information server.

4. The method according to claim 1, wherein the receiving of the positive acknowledgement message from the information server comprises:
receiving from the information server a negative acknowledgement message representing rejection of the changed information; and
re-transmitting the message including corrected information to the information server.

5. The method according to claim 4, wherein the receiving of the negative acknowledgement message and the re-transmitting of the message including the corrected information are repeated a predetermined number of times.

6. The method according to claim 1, wherein the receiving of the positive acknowledgement message from the information server comprises:
waiting for the positive acknowledgement message to be transmitted from the information server within a predetermined period of time; and
re-transmitting the message including the changed information to the information server after the predetermined period of time has elapsed.

7. The method according to claim 1, wherein the receiving of the positive acknowledgement message from the information server comprises:
receiving from the information server a negative acknowledgement message representing rejection of some of the changed information; and
re-transmitting the message including corrected information to the information server.

8. The method according to claim 7, wherein the negative acknowledgement message representing rejection of some of the changed information comprises a list of the rejected information.

9. An apparatus to manage information about a mobile network service and to manage a network providing the mobile network service, the apparatus comprising:
an information change identification unit to identify a change in the information about the mobile network service;
an information transmission unit to transmit a message including the changed information to an information server; and
a positive acknowledgement message receiving unit to receive a positive acknowledgement message from the information server representing acceptance of the changed information.

10. The apparatus according to claim 9, wherein the message including the changed information comprises:
a field describing the type of the message;
a field describing the length of the message; and
a field describing the changed information.

11. The apparatus according to claim 9, wherein the information transmission unit formats the changed information in a Markup language and transmits the message to the information server.

12. The apparatus according to claim 9, wherein the positive acknowledgement message receiving unit comprises:
a negative acknowledgement message receiving unit to receive a negative acknowledgement message from the information server representing rejection of the changed information; and
a message re-transmission unit to re-transmit the message including corrected information to the information server.

13. The apparatus according to claim 12, wherein the reception of the negative acknowledgement message and the re-transmission of the message including the corrected information are repeated a predetermined number of times.

14. The apparatus according to claim 9, wherein the positive acknowledgement message receiving unit comprises:
a message waiting unit to wait for the positive acknowledgement message to be transmitted from the information server within a predetermined period of time; and
a message re-transmission unit to re-transmit the message including the changed information to the information server after a lapse of the predetermined period of time.

15. The apparatus according to claim 9, wherein the positive acknowledgement message receiving unit comprises:
a negative acknowledgment message receiving unit to receive a negative acknowledgement message from the information server representing rejection of some of the changed information; and
a partial information re-transmission unit to re-transmit the message including corrected information to the information server.

16. The apparatus according to claim 15, wherein the negative acknowledgement message representing non-acceptance of some of the changed information comprises a list of the rejected information.

17. A computer-readable recording medium having computer-executable instructions to perform a method comprising:
identifying a change in information about a mobile network service;
transmitting a message including the changed information to an information server; and
receiving a positive acknowledgement message from the information server representing acceptance of the changed information, using the management server.

18. A network to provide a mobile network service, the network comprising:
an information server to store information about the network for use in a handover of a mobile node in the network; and
a management server to manage the network and to identify a change in the information about the network, to transmit a message with the changed information to the information server, and to receive an acknowledgement from the information server representing receipt and acceptance of the changed information.

19. The network according to claim 18, wherein the message including the changed information comprises:
a field describing the type of the message;
a field describing the length of the message; and
a field describing the changed information.

20. The network according to claim 18, wherein the management server formats the changed information in a markup language and transmits the message including the formatted changed information to the information server.

21. The network according to claim 18, wherein:
the information server transmits a negative acknowledgment message representing rejection of the changed information; and
the management server re-transmits the message in response to receiving the negative acknowledgement message.

22. The network according to claim 21, wherein the information server transmits the negative acknowledge message and the management server re-transmits the message a predetermined number of times.

23. The network according to claim 18, wherein the management server waits to receive the acknowledge message for a predetermined time and re-transmits the message if no acknowledge message is received after the predetermined time has elapsed.

24. The network according to claim 18, wherein:
the information server transmits a negative acknowledgement message representing rejection of some of the changed information; and
in response to receiving the negative acknowledgement message, the management server re-transmits the message including corrected information.

25. The network according to claim 24, wherein the negative acknowledgement message representing rejection of some of the changed information comprises a list of the rejected information.

26. A method of managing information about a mobile network service in a server that manages a network providing the mobile network service, the method comprising:
transmitting an update message including information about a detected change in the mobile network service to an information server; and
receiving from the information server an acknowledgement message indicating acceptance or rejection of the changed information.

27. The method according to claim 26, wherein the update message comprises:
a field describing the type of the message;
a field describing the length of the message; and
a field describing the changed information.

28. The method according to claim 26, wherein the receiving of the acknowledgement message from the information server comprises:
receiving from the information server a negative acknowledgement message representing rejection of the changed information; and
re-transmitting the message including corrected information to the information server.

29. The method according to claim 28, wherein the receiving of the negative acknowledgement message and the re-transmitting of the message including the corrected information are repeated a predetermined number of times.

30. The method according to claim 26, wherein the receiving of the acknowledgement message from the information server comprises:
waiting for the acknowledgement message to be transmitted from the information server within a predetermined period of time; and
re-transmitting the message including the changed information to the information server after the predetermined period of time has elapsed.

31. The method according to claim 26, wherein the receiving of the acknowledgement message from the information server comprises:
receiving from the information server a negative acknowledgement message representing rejection of some of the changed information; and
re-transmitting the message including corrected information to the information server.

32. The method according to claim 31, wherein the negative acknowledgement message representing rejection of some of the changed information comprises a list of the rejected information.

33. The method according to claim 26, wherein the acknowledgement message comprises:
a field describing the type of the message;
a field describing the length of the message; and
a field containing any information rejected by the information server.
